(19) United States
(12) Patent Application Publication
(10) Pub. No.: US 2008/0153603 A1
(43) Pub. Date: Jun. 26, 2008

(54) Camshaft adjusting device

(76) Inventors: Matthias Gregor, Stuttgart (DE); Jens Meintschel, Esslingen (DE); Thomas Stolk, Kirchheim (DE); Alexander von Gaisberg-Helfenberg, Beilstein (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 12/002,785

(22) Filed: Dec. 18, 2007

Related U.S. Application Data
(63) Continuation-in-part of application No. PCT/EP2006/005452, filed on Jun. 8, 2006.

(30) Foreign Application Priority Data
Jun. 18, 2005 (DE) 10 2005 028 313.6

(51) Int. Cl. F16D 3/10

(52) U.S. Cl. 464/1; 123/90.17

(57) ABSTRACT

In a camshaft adjusting device for an internal combustion engine, wherein the adjustmen device includes a brake unit which has at least one eddy-current brake for generating a braking torque (Mb) which correlates with a phase angle of a camshaft, a supplementary unit is provided to at least supplement the eddy-current brake with respect to its adjusting function in at least one operating range.

This is a Continuation-In-Part Application of pending International pending Application PCT/EP2006/005452 filed Jun. 8, 2006 and claiming the priority of German patent application 10 2003 028 313.6 filed Jun. 8, 2005.

### BACKGROUND OF THE INVENTION

The invention relates to a camshaft adjusting device including an additional brake unit, in particular for an internal combustion engine.

DE 103 24 845 A1 discloses a camshaft adjusting device for an internal combustion engine which has an epicyclic gearing unit and a brake unit which is formed by a hysteresis brake, by means of which a braking force can be generated for adjusting a camshaft phase angle.

It is the principal object of the present invention to provide a camshaft adjusting device which is cost-effective, can be subjected to high thermal loads and is of particularly space-saving design.

### SUMMARY OF THE INVENTION

In a camshaft adjusting device for an internal combustion engine, wherein the adjustmen device includes a brake unit which has at least one eddy-current brake for generating a braking torque (Mb) which correlates with a phase angle of a camshaft, a supplement unit is provided to at least supplement the eddy-current brake with respect to its adjusting function in at least one operating range.

“Supplement” is to be understood to mean that the supplementary unit is provided in particular to hold a phase angle of the camshaft constant, and/or to adjust the phase angle in the early direction and/or in the late direction, in the at least one operating range.

By means of the solution according to the invention, it is possible in certain operating ranges, such as in particular in low engine speed ranges, and particularly in operating ranges below an idle rotational speed of the internal combustion engine, that a braking force which supplements an eddy current braking force is generated by means of the supplementary unit. It is also possible to prevent an adjustment of the phase angle of the camshaft by means of a locking action. Rotors of eddy-current brakes can be designed in a cost-effective manner such that they can be highly loaded thermally and mechanically, as a result of which the eddy-current brake can be of particularly space-saving design overall with low weight. An “eddy-current brake” should be understood in this context to mean in particular a brake whose operating principle is based at least largely on the generation of eddy currents, but can also have other brake components such as in particular hysteresis brake components. In addition, a “braking torque which correlates with a phase angle” is to be understood to mean a dependency in which different adjusting modes can be obtained with different magnitudes of braking torque.

The supplementary unit can be formed by different units which would appear to be expedient to a person skilled in the art, such as by a non-contact brake unit, for example a hysteresis brake, a contact brake unit, for example a brake with friction plates, and/or advantageously also by a locking unit, by means of which a phase angle of the camshaft can be held constant or an adjustment of the phase angle of the camshaft can be prevented in a structurally simple and cost-effective manner by means of a force-fitting and/or in particular by means of a form-fitting connection. The locking unit preferably serves in particular to rotationally fixedly couple at least two shafts of an epicyclic gearing which is embodied as a planetary gearing, in order to thereby lock the epicyclic gearing or prevent an adjustment of a phase angle of the camshaft.

If the supplementary unit is formed at least partially in one piece with the eddy-current brake, it is possible to save on additional components, installation space, weight and assembly expenditure. The eddy-current brake could advantageously additionally be embodied as a hysteresis brake, so that, in particular in all operating ranges, a sum of a generated eddy-current braking component and of a generated hysteresis braking component is sufficient to obtain a desired braking torque, for example by means of a specific embodiment of a rotor of the eddy-current brake, and/or the eddy-current brake could additionally be utilized as a friction brake and/or as a locking device, which can be realized in a structurally simple fashion with a rotor, which is movable in the axial direction, of the eddy-current brake.

In a further embodiment of the invention, it is proposed that the camshaft adjusting device has at least one preliminary transmission stage which is arranged upstream of the brake unit and is provided for a rotational speed increase in the direction of the brake unit. It is thereby possible to realize high rotational speeds within the brake unit, in particular within the eddy-current brake, so that sufficient braking torque can be obtained by means of the eddy-current brake even at low internal combustion engine rotational speeds. It is possible in particular for the operating range in which the eddy-current brake is at least supplemented in terms of its adjusting function by the supplementary unit to preferably be limited to a range below an idle rotational speed of the internal combustion engine. In addition, the preliminary transmission stage can advantageously be utilized to compensate tolerance-induced or thermal-expansion-induced offset between the brake unit and an epicyclic gearing unit. Here, for advantageous compensation of an angular offset, the preliminary transmission stage can also be designed with a convex toothing.

If the preliminary transmission stage is formed at least partially in one piece with an epicyclic gearing unit, it is again possible to save on components, installation space, weight and assembly expenditure.

It is additionally proposed that the eddy-current brake has a pole structure which is arranged at both sides with respect to a rotor, as a result of which a high efficiency can be obtained.

The invention will become more readily apparent from the following description of exemplary embodiments of the invention.

### BRIEF DESCRIPTION OF THE DRAWINGS

FIG. 1 is a diagrammatic illustration of a camshaft adjusting device,

FIG. 2 shows an eddy-current brake with an arrangement of a pole structure and a band-shaped region of action,

FIG. 3 shows a detail of a schematically illustrated pole structure of the eddy-current brake with poles situated opposite one another,

FIG. 4 shows a detail of a further schematically illustrated pole structure with poles arranged offset,

FIG. 5 is a diagrammatic illustration of a further camshaft adjusting device with a preliminary trans-mission stage,

FIG. 6 shows an eddy-current brake of the camshaft adjusting device from FIG. 5 with an arrangement of a pole structure at both sides and a disk-shaped region of action,

FIG. 7 shows a braking torque profile against an internal combustion engine rotational speed,

FIG. 8 is a diagrammatic illustration of a further camshaft adjusting device with a stepped sun gear,

FIG. 9 shows an eddy-current brake of the camshaft adjusting device from FIG. 8 with a single-sided arrangement of a pole structure and a band-shaped region of action,

FIG. 10 shows a detail of a schematically illustrated pole structure of the eddy-current brake from FIG. 9 with poles arranged at one side,

FIG. 11 is a diagrammatic illustration of a further camshaft device with a continuous sun gear toothing, and

FIG. 12 shows a further eddy-current brake with a single-sided arrangement of the pole structure and a disk-shaped region of action.

### DESCRIPTION OF A PARTICULAR EMBODIMENT

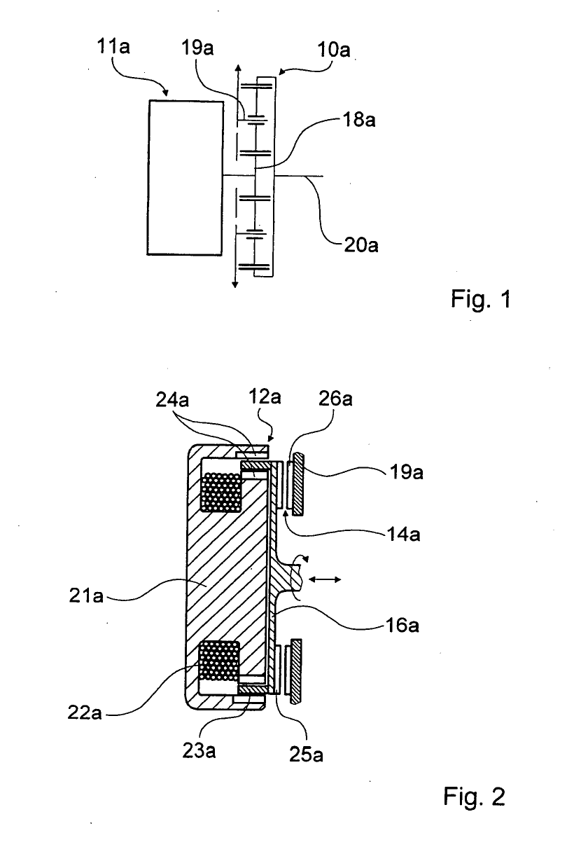

FIG. 1 shows a camshaft adjusting device for an internal combustion engine having an epicyclic gearing unit 10a and a brake unit 11a. The epicyclic gearing unit 10a is formed by a planetary gear set which is embodied as a minus gearing in which, in the event of a theoretical drive of a sun gear 18a when the planet carrier 19a is held fixed, an adjusting input which is coupled to the brake unit 11a and an output, which is coupled to a camshaft 20a, of the epicyclic gearing unit 10a rotate in different directions. The planet carrier 19a is coupled by means of a toothed belt to a crankshaft (not illustrated in any more detail) of the internal combustion engine, and is driven by the latter in operation.

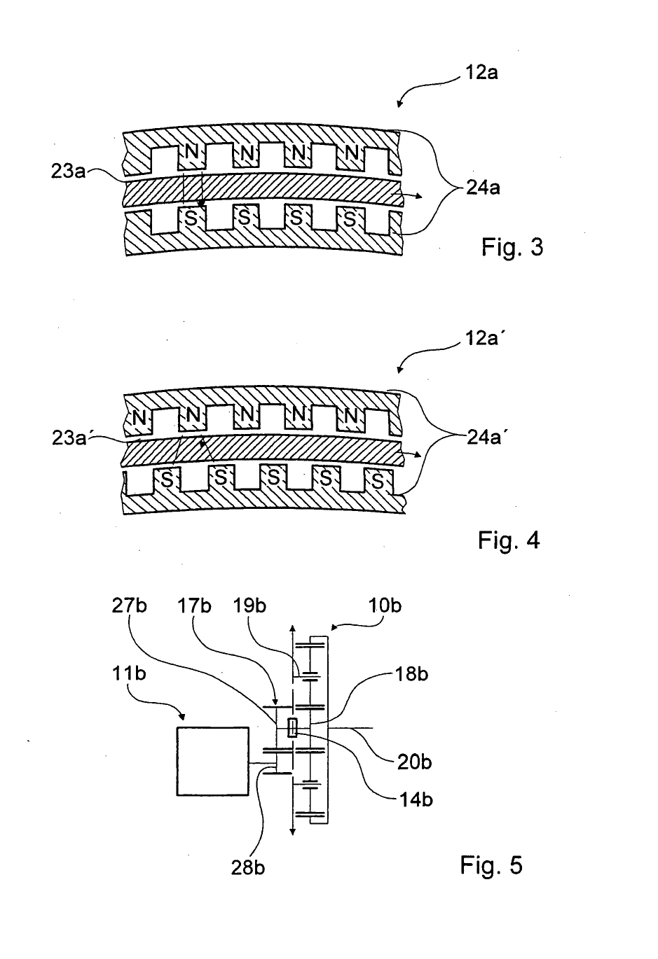

The brake unit 11a comprises an eddy-current brake 12a for generating a braking torque which correlates with a phase angle of the camshaft 20a, and a supplementary unit 14a which is formed in one piece with the eddy-current brake 12a. The supplementary unit 14a is provided to supplement or replace the eddy-current brake 12a in terms of its adjusting function in a low operating range with respect to an internal combustion engine rotational speed (FIG. 2). The eddy-current brake 12a comprises a rotor 16a, a stator 21a, an exciter coil 22a which is attached to the stator 21a, a band-shaped or sleeve-shaped eddy-current unit 23a which is fastened to the rotor 16a and is composed of copper, and a pole structure 24a which is arranged at both sides with respect to the eddy-current unit 23a. Instead of copper, the eddy-current unit 23a could also be produced from some other material which would appear to be expedient to a person skilled in the art, such as for example of aluminum etc. The pole structure 24a has poles which are situated opposite one another (FIG. 3), but it also is possible for said poles to be arranged offset (FIG. 4).

The supplementary unit 14a is formed by a locking unit, by means of which the sun gear 18a and the planet carrier 19a can be rotationally fixedly coupled. The rotor 16a is for this purpose designed so as to be movable in the axial direction, and has, on a side which faces away from the stator 21a of the eddy-current brake 12a, a toothing 25a which can, for locking, be placed in engagement with a toothing 26a which is integrally formed on the planet carrier 19a (FIG. 2).

When the internal combustion engine is started, shortly before an idle rotational speed is reached, the supplementary unit 14a is unlocked as the exciter coil 22a is energized and the rotor 16a is thereby pulled out of its locking position counter to the force of a spring (not illustrated) in the direction of the stator 21a, so that the sun gear 18a and the planet carrier 19a can rotate with different rotational speeds and a phase angle of the camshaft 20a can be adjusted.

If a constant phase position of the camshaft 20a is subsequently to be set, then a braking torque is generated by means of the eddy-current brake 12a, so that the camshaft 20a rotates with half of the crankshaft rotational speed. If an adjustment is to be carried out in the early direction, the braking torque is increased with respect to the braking torque generated at a constant phase angle. If an adjustment is to be carried out in the late direction, the braking torque is reduced in relation to the braking torque as generated for maintaining a constant phase angle.

When the internal combustion engine is switched off, below the idle rotational speed, the supplementary unit 14a is locked again by virtue of the exciter coil 22a being deactivated and the rotor 16a is pushed in the axial direction toward the planet carrier 19a by means of the spring, so that the rotor 16a and therefore the sun gear 18a are coupled in a form-fitting manner in the peripheral direction to the planet carrier 19a. As a result, the sun gear 18a and the planet carrier 19a and therefore the entire epicyclic gearing unit 10a subsequently rotate as a unit. Instead of, or in addition to, the exciter coil 22a, at least one further coil and/or an alternative actuator may be provided in order to move the rotor 16a in the axial direction.

FIGS. 5 to 12 illustrate further exemplary embodiments. Substantially identical components are denoted fundamentally by the same reference symbols, with the letters a-d being added to the reference symbols in order to distinguish the exemplary embodiments. In addition, with regard to identical features and functions, reference can be made to the description with regard to the exemplary embodiment in FIGS. 1 to 4. The following description is restricted substantially to the differences with respect to the exemplary embodiment in FIGS. 1 to 4.

FIG. 5 illustrates a camshaft adjusting device of an internal combustion engine which has a preliminary transmission stage 17b which is arranged between a brake unit 11b and an epicyclic gearing unit 10b and is provided for a rotational speed increase in the direction of the brake unit 11b. The preliminary transmission stage 17 has a first spur gear 27b which is coupled to a sun gear 18b and a second spur gear 28b which meshes with the spur gear 27b, which second spur gear 28b is coupled to an input shaft of the brake unit 11b.

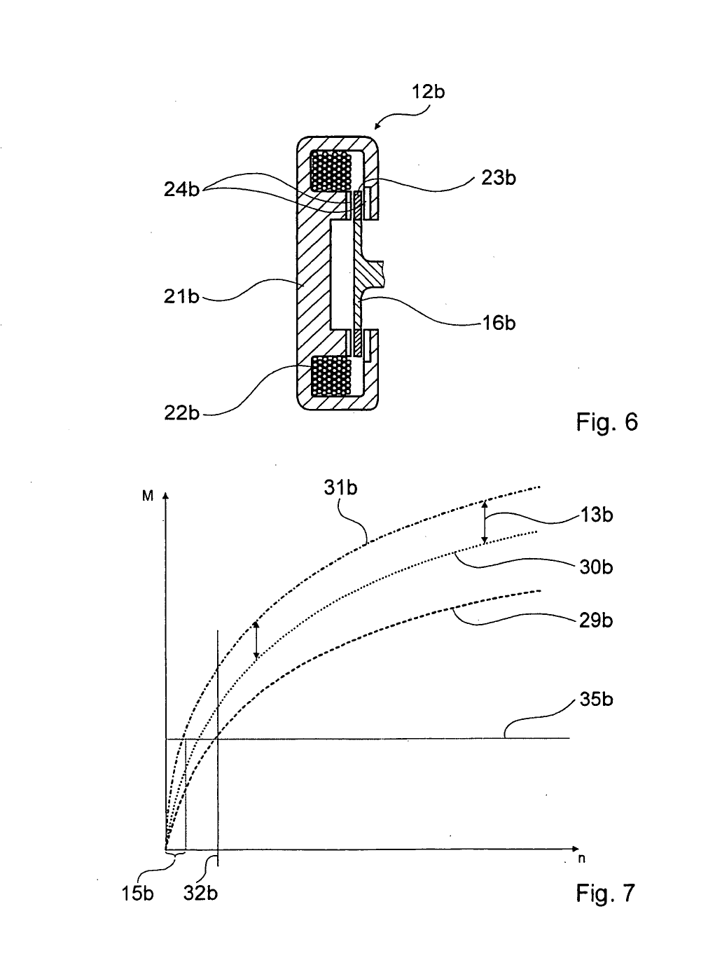

The brake unit 11b comprises an eddy-current brake 12b for generating a braking torque Mb which correlates with a phase angle of the camshaft 20b, and a supplementary unit 14b which is provided to supplement or replace the eddy-current brake 12b in terms of its adjusting function in a low operating range 15b with respect to an internal combustion engine rotational speed (FIGS. 6 and 7). The eddy-current brake 12b comprises a rotor 16b, a stator 21b, an exciter coil 22b which is attached to the stator 21b, a disk-shaped eddy-current unit 23b which is fastened to the rotor 16b and is composed of copper, and a pole structure 24b which is arranged at both sides with respect to the eddy-current unit 23b.

The supplementary unit 14b is formed by a locking unit, by means of which the sun gear 18b and a planet carrier 19b of the epicyclic gearing unit 10b can be rotationally fixedly connected.

FIG. 7 illustrates a profile of a braking torque Mb of the brake unit 11b against an internal combustion engine rotational speed n of the camshaft adjusting device from FIG. 5. Here, a line 29b denotes a theoretical profile of a torque which is generated solely by means of eddy-current components without the preliminary transmission stage 17b, a line 30b denotes a theoretical profile of a torque which is generated solely by means of eddy-current components with the preliminary transmission stage 17b, and a line 31b denotes a profile of a torque which is generated by means of eddy-current components and hysteresis components 13b with the preliminary transmission stage 17b.

When the internal combustion engine is started, shortly before an idle rotational speed 32b is reached, the supplementary unit 14b is unlocked, specifically once a sufficient braking torque 35b can be imparted by the eddy-current brake 12b. When the internal combustion engine is switched off, below the idle rotational speed, the supplementary unit 14b is locked again, so that an adjustment of a phase angle of the camshaft 20b is prevented. Here, a braking torque Mb is generated with a profile which is substantially reflected about a vertical.

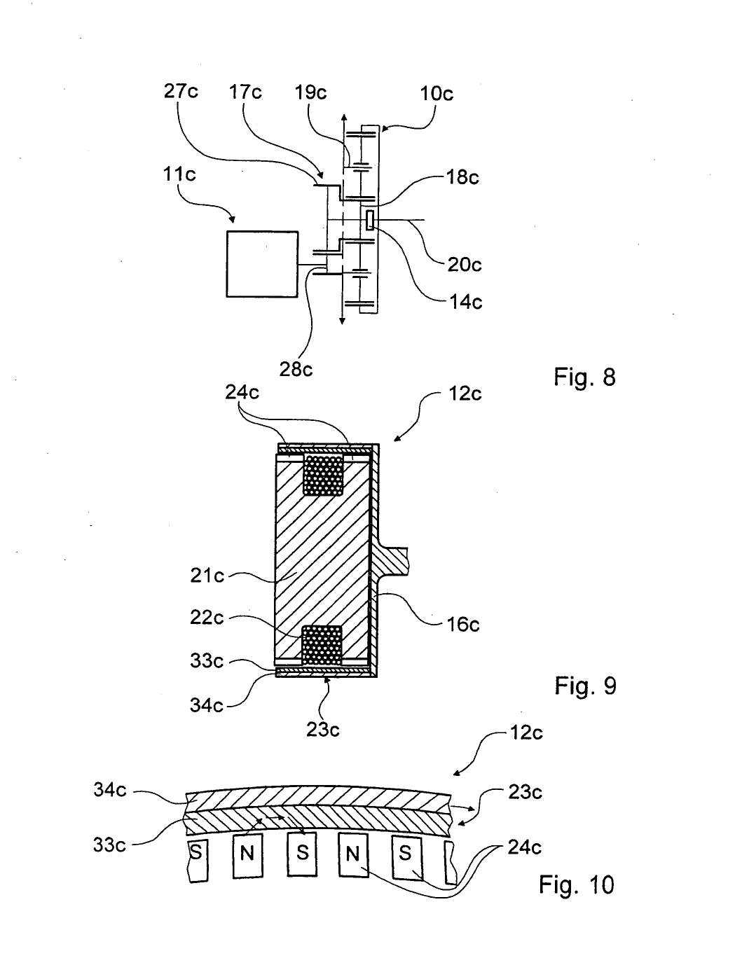

FIG. 8 illustrates a camshaft adjusting device of an internal combustion engine which has a preliminary transmission stage 17c which is arranged between a brake unit 11c and an epicyclic gearing unit 10c and is provided for a rotational speed increase in the direction of the brake unit 11c. The epicyclic gearing unit 10c has a two-stage stepped sun gear 18c which is formed in one piece with a spur gear 27c of the preliminary transmission stage 17c, with the spur gear 27c having a larger diameter than the sun gear part, which meshes with planets of the epicyclic gearing unit 10b, of the stepped sun gear 18c.

The brake unit 11c comprises an eddy-current brake 12c for generating a braking torque which correlates with a phase angle of a camshaft 20c, and a supplementary unit 14c which is provided to supplement or replace the eddy-current brake 12c in terms of its adjusting function in a low speed operating range with respect to an internal combustion engine rotational speed (FIG. 9).

The supplementary unit 14c is a lock-up unit, by means of which the stepped sun gear 18c and the camshaft 20c can be rotationally fixedly connected, and therefore a phase adjustment can be prevented.

The eddy-current brake 12c comprises a rotor 16c, a stator 21c, an exciter coil 22c which is attached to the stator 21c, a band-shaped or sleeve-shaped eddy-current unit 23c which is fastened to the rotor 16c, and a pole structure 24c which is arranged at one side with respect to the eddy-current unit 23c and which comprises two different-polarity regions of action arranged in series in the axial direction (FIGS. 9 and 10). The eddy-current unit 23c is of two-layer construction, and the eddy-current unit 23c specifically has, on a radially inner side which faces toward the pole structure 24c, a non-soft-magnetic layer 33c composed of copper, and on a radially outer side which faces away from the pole structure 24c, a soft-magnetic layer 34c composed of iron is provided. An advantageous return flow can be obtained by means of the soft-magnetic layer 34c. Also fundamentally conceivable are however other materials which would appear to be expedient to a person skilled in the art, or a single-layer eddy-current unit 23c.

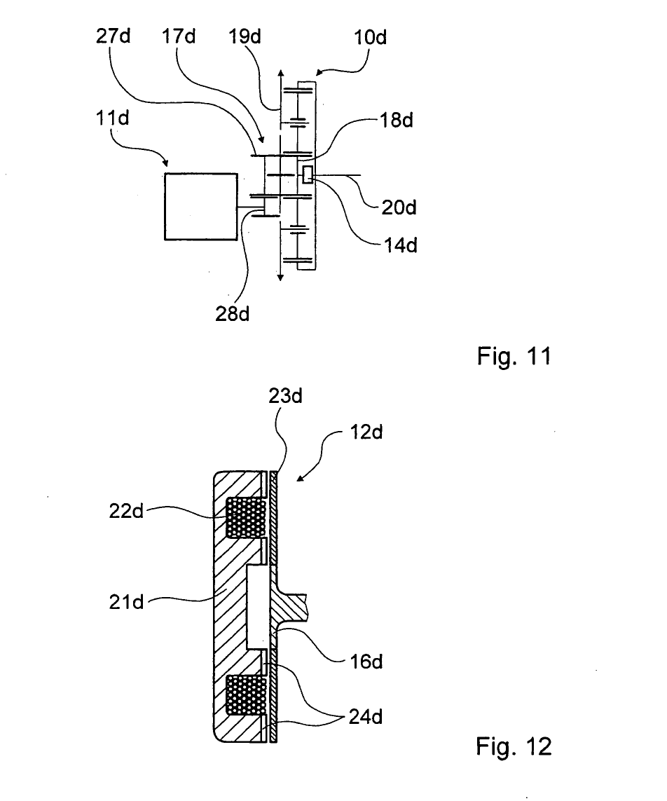

FIG. 11 illustrates a camshaft adjusting device of an internal combustion engine which has a preliminary transmission stage 17d which is arranged between a brake unit 11d and an epicyclic gearing unit 10d and is provided for a rotational speed increase in the direction of the brake unit 11d. The epicyclic gearing unit 10d has a sun gear 18d with a continuous toothing which extends outward in the direction of the brake unit 11d and which is formed in one piece with a spur gear 27d of the preliminary transmission stage 17d.

The brake unit 11d comprises an eddy-current brake 12d for generating a braking torque which correlates with a phase angle of a camshaft 20d, and a supplementary unit 14d which is provided to supplement or replace the eddy-current brake 12d in terms of its adjusting function in a low speed operating range with respect to an internal combustion engine rotational speed (FIGS. 11 and 12).

The supplementary unit 14d is formed by a locking unit, by means of which the sun gear 18d and the camshaft 20d can be rotationally fixedly connected.

The eddy-current brake 12d comprises a rotor 16d, a stator 21d, an exciter coil 22d which is attached to the stator 21d, a disk-shaped eddy-current unit 23d which is fastened to the rotor 16d and is composed of copper, and a pole structure 24d which is arranged at one side with respect to the eddy-current unit 23d and comprises two different-polarity regions of action arranged in series in the radial direction.

What is claimed is:

1. A camshaft adjusting device for an internal combustion engine, having a brake unit (11a-11d) comprising at least one eddy-current brake (12a-12d) for generating a braking torque (Mb) which correlates with a phase angle of a camshaft (20a-20d), and having a supplementary unit (14a-14d) which is provided to at least supplement the eddy-current brake (12a-12d) in terms of its adjusting function in at least one operating range (15b).

2. The camshaft adjusting device as claimed in claim 1, wherein the supplementary unit (14a-14d) is formed by a locking unit.

3. The camshaft adjusting device as claimed in claim 1, wherein the supplementary unit (14a) is formed in one piece with the eddy-current brake (12a).

4. The camshaft adjusting device as claimed in claim 3, wherein the eddy-current brake (12a) has a rotor (16a) which is movable in the axial direction.

5. The camshaft adjusting device as claimed in claim 1, including at least one pre-transmission stage (17a-17d) which is arranged upstream of the brake unit (11b-11d) and is provided for a rotational speed increase in the direction of the brake unit (11b-11d).

6. The camshaft adjusting device as claimed in claim 5, including an epicyclic gearing unit (10c, 10d) which is formed at least partially in one piece with the pre-transmission stage (17c, 17d).

7. The camshaft adjusting device as claimed in claim 1, wherein the eddy-current brake (12a, 12b) includes a pole structure (24a, 24b) which is arranged at both sides of a rotor (16a, 16b).

8. An internal combustion engine having a camshaft adjusting device including a brake unit having a supplementary unit (14a-14d) which is provided to at least supplement the eddy-current brake (12a-12d) in terms of its adjusting function in at least one operating range (15b).
